(19) United States
(12) Patent Application Publication
(10) Pub. No.: US 2007/0174454 A1
(43) Pub. Date: Jul. 26, 2007

(54) Method and apparatus for accessing Web services and URL resources for both primary and shared users over a reverse tunnel mechanism

(76) Inventors: David C. Mitchell, Orem, UT (US); Joseph C. Ekstrom, Orem, UT (US); Lin Salisbury, Orem, UT (US); Scott E. Hamilton, Ceder Hills, UT (US)

Correspondence Address: GOODWIN PROCTER LLP;PATENT ADMINISTRATOR, EXCHANGE PLACE, BOSTON, MA, 02109-2881, US

(21) Appl. No.: 11/337,279

(22) Filed: Jan. 23, 2006

(51) Int. Cl. G06F 15/173

(52) U.S. Cl. 709/225

(57) ABSTRACT

A method and apparatus for accessing Web services and URL resources for both primary and shared users over a reverse tunnel mechanism are provided. Current limitations on accessing Web services and URL resources located behind firewalls or otherwise made secure and largely inaccessible are overcome through a novel use of a “reverse tunneling” mechanism. The mechanism uses an Agent to obfuscate physical address endpoints of Web services and other resources, as well as to package SOAP service requests in such a way that they can be passed through firewalls unimpeded. All of this data transfer is made secure through encryption, strong authentication, and by making use of the security environment on both a user's individual device and the LAN proper. In addition, a primary user may share data access rights within the secure LAN environment to a secondary user and, using the present invention, provide only those access rights to the shared user over the open Internet.

### BACKGROUND OF THE INVENTION

1. Field of the Invention

This invention relates to the area of tunneling, and more specifically, to using a tunneling mechanism to securely access Web services and URL resources located on a network protected by a firewall, and make those resources securely available to strongly authenticated users in the open Internet environment.

2. Background Art

As the Internet grew in importance as a business communications backbone, keeping corporate data secure from Internet raiders known as “hackers” became a top priority. The creation of “firewalls” (hardware, software, or both), data protection devices that effectively block all unwanted incoming Internet traffic, created a second problem while solving the first.

In order to make a corporate network secure, firewall administrators close down all but a few needed ports into the corporate site and drastically restrict the types of data allowed to be transferred in and out of the corporate Local Area Network (LAN) which the firewall protects. For example, the most well known Internet communications port, port 80, allows only Hyper Text Transfer Protocol (HTTP) clear text traffic. Unfortunately, while firewalls do provide protection by making it possible for corporate network administrators to restrict both ports and data content types, needed firewall configurations often hinder effective business and private communications that are both harmless and business strategic.

The frustrations caused when firewalls limit legitimate user and business access to data and resources led to the invention of tunneling. Tunneling describes the process used to securely access a LAN through a firewall by using a standard port and protocol (such as port 80, using HTTP) and then overlaying on top of that standard protocol a different type of data format than that originally meant to be used on that port and protocol. Tunneling can also be described as the process of placing one data packet (the basic unit of in Internet communications) inside another so that the data can be passed through a firewall effectively.

Because tunneling often uses data encryption to provide security, this encryption ensures that even though a communication is sent across the wide open (unprotected) Internet, the data stream can not be interpreted by unintended recipients. In addition, some tunneling protocols provide an integrity check component that ensures data cannot be added to, deleted from, or hacked. RealAudio's media file streaming provides an example of this type of data tunneling. RealAudio was one of the early commercial pioneers of tunneling, passing media content to interested consumers over port 80 by “piggybacking” music and other media files on the HTTP protocol in such a way that firewalls do not block the incoming stream of data.

In the tunneling descriptions provided above, data is passed from outside the firewall into a secure corporate site. Tunneling has also been used to pass data from a secure LAN behind the firewall out to a user on the Internet, using a technique sometimes called “screen-scraping”. Although there are different technical methods used to achieve this affect, the basic process used scans an image of a corporate user's desktop and then passes that image across the network to the remote location. This allows the user on the Internet to access files and accomplish work using the same familiar user interface available on the physically remote machine. This type of tunneling allows two way communication and when encrypted, creates a point to point Virtual Private Network (VPN). Prime examples of this type of tunneling technology are Microsoft's Remote Desktop Protocol (RDP) and Citrix's MetaFrame Server and Independent Computing Architecture (ICA) protocol. GoToMyPC also provides this type of access.

Virtual Private Networks are powerful in that they make remote access and work possible, yet they are very clumsy because they are image based. Sending screen content through a tunneling mechanism requires the transfer (both to and from the remote location) of very large amounts of data. These “screen-scraping” techniques are very bandwidth heavy and often result in very noticeable latency issues, leading to high levels of frustration among those who depend on this methodology to remotely access their corporate data. In addition, some tunneling protocols are not as secure as others.

It is this frustration with bandwidth issues, as well as ongoing concerns with security, that has led to the markedly increased interest in Web applications that can be both securely run from any location, and combine Web services from a variety of sources to create powerful new applications that are not bound by the constraints imposed by VPNs and screen-scraping techniques. The current industry hype over Asynchronous JavaScript and XML (AJAX) applications indicates the pent-up demand for Web applications that perform without the latency issues inherent in screen-scraped applications, yet are as, or more secure than VPNs.

With the mounting use of Web services to create highly integrated Web applications, the need for seamless data access is on the rise, regardless of where that data originates. A standard protocol used in accessing Web services is the Simple Object Access Protocol (SOAP). SOAP is used to encode and transmit Extensible Mark Up Language (XML) syntax to provide access to business logic and data anywhere on the Web, regardless of originating language or operating system. SOAP is most often sent over HTTP on port 80, however firewalls routinely block incoming SOAP service requests in this format as a matter of standard security. This safeguard is of the type that led to the innovation of tunneling in the first place. Currently however, there is no secure procedure for accessing Web services and URL resources securely located behind a secured network such as a corporate LAN.

### SUMMARY OF THE INVENTION

An embodiment of the invention may provide a way to stream and access Web services and URL resources over another allowed or more standard protocol and port in a secure fashion. An embodiment of the present invention may use established tunneling techniques to innovatively pass logical and semantic bits of data, as well as application resources, from a secure LAN by “piggy-backing” a Web service such as a service using the SOAP protocol over another allowed or more standard protocol such as the HTTP protocol on port 80.

An embodiment of the invention may consist of a small piece of tunnel enabling code called an “Agent” working in conjunction with a secure hosting or data center. Access to the LAN may be provided by a user downloading and installing a small piece of code onto a device where the code may run inside the LAN as an “Agent,” very much like Google Desktop, or other types of client-side code that an individual may elect to install on a device within a secure environment. The person downloading the Agent may also create an authenticated personal account with a hosting center, typically at the time of the Agent download. Once the user has downloaded this Agent, access to the Agent may only be granted by providing strongly authenticated user credentials to a “Middleware Server” running within a secure hosting or data center.

Once the user creates an account on the data center and the tunnel Agent is installed, the user may access browser-based middleware applications running on the data center's Middleware Servers, and through that means, also access the Agent on the LAN-based device securely from anywhere on the Web. With one embodiment of the present invention, this means that all local Agent, resources, and device information including file access, e-mail, local e-mail archive files (such as in a .PST format), and any search capability on the machine with the Agent, are remotely accessible. For example, in an implementation of the present invention, if the person who downloads the Agent has the Google Desktop application installed on their machine, the user may be able to accomplish a search from a remote Web browser, and the results of that search may be passed back through the tunnel and seamlessly presented to the user at the remote location.

In addition to local Agent, resources, and device access, any Web services operating on the LAN on which the device or computer is located may also be available, depending on the access rights of the user profile under which the Agent is installed on the device. Any rights that user has to access Web services on the network may be made available to the same user remotely. Web service access may be made possible through programmatic “discovery,” or because a user may register a Web service interface with the Agent.

The Agent may use the user's credentials to initiate a SOAP request to the internal service being accessed, and returned results may be passed through the tunnel protocol out to the Middleware Server running in the hosting center. The Middleware Server may integrate the new service with other services already running, and present a rich, thin, Graphical User Interface (GUI) to the user.

This generic service access may be made more secure by using an indirection table in the tunneling Agent, to hide the true address where the service resides behind the secured network firewall. The information hiding may be furthered at the secure hosting center where at the time of download and user account creation the middleware application server serving any applications to which the person installing the Agent has rights, may use a Tunnel Identification number (TID) from the tunnel Agent to obscure the final destination of any service calls.

Once a user opens a browser remotely and provides their authentication (i.e., log-in) credentials, the resources requested may be identified by the TID number assigned by a middleware communications “Broker” and by an indirection table's mapped names, which may only be mapped to the actual resources by the Agent located within the firewall protected LAN. In this way, both SOAP services and needed LAN-based Uniform Resource Locator (URL) resources may be made available to a user of a hosted middleware application being accessed in the open Internet, without communication of Web service and URL resource location information.

Embodiments of the invention enable secure, Web-based application access to previously unreachable resources—SOAP services and URL resources, without the requirement for the administrator of the secured network to expose the LAN and said services through an end point or Web server destination, as currently must be done. This may obviate the need for the use of traditional methods to make corporate resources available to the outside world, such as use of a File Transfer Protocol (FTP) server, a Gopher server, or a Web server. In other words, URLs, as well as SOAP services, may be provided without installing a web server inside the secured network.

Replacing the typical traditional requirement to create security exposure points in the environment by “punching holes in the firewall” in order to access secured network resources at the semantic or logical level is very useful. Rather than creating such exposure points for hackers to try to violate the secured network firewall, an isolated and standards-based mechanism for external access of resources located within a protected LAN can be achieved.

### BRIEF DESCRIPTION OF THE DRAWINGS

FIG. 1 is block diagram showing a physical arrangement and logical separation of hardware and software application components used in one implementation of the present invention.

FIG. 2 is a diagram of possible communication paths between application elements in one implementation of the present invention.

FIG. 3 is a labeled URL string showing an example of how different string components are joined together to create a URL typical of the type meant to run a Middleware Server-based Web application that accesses LAN-based services in one implementation of the present invention.

### DETAILED DESCRIPTION OF THE INVENTION

A method and apparatus for securely accessing Web services and URL resources located within a protected environment, such as a corporate LAN, from outside that environment are described. In the following description of the method and apparatus, many specific details are provided to offer a more thorough explanation of embodiments of the invention. To one skilled in the art, however, it will be clear that the invention may be accomplished without these specific details. In other cases, obvious elements have not been described at length, so as not to render the invention ambiguous.

Terminology

Throughout the following explanation, mention of a “user” may refer either to a person interacting with a computer interface, to one or more software program elements (such as a user interface), or both. A program element may be any element of a computer program, whether that executes remotely or locally, as that element interacts with an embodiment or embodiments of the invention. Program elements may interact with an embodiment of the invention based on programmatic cues such as event triggers that are dependant upon occurrences of an action (such as downloading a file, or connecting to a running application), whether that action is taken by a person or another program element. Throughout the following, “programmatic discovery” may refer to the use of a program element to identify and take action on data encountered during the operation of a program or program element.

Throughout the following description, reference to a “Web service” or services may be generalized to refer to any software system using standard protocols for device-to-device communications across a network. Mention of a Simple Object Access Protocol (SOAP) service or services in the following description may be construed as only one of many examples of a Web service or services which may be used in embodiments of the invention. Throughout the following explanation, SOAP may be used as a generic place holder for any standard Web service protocol which may or may not include the Simple Object Access Protocol.

Throughout the following description, “standard” or “standards” may refer to computing and communications standards introduced and supported by official bodies such as the World Wide Web Consortium (W3C) or The Internet Engineering Task Force (IETF). Likewise, standard may refer to any methodology used to achieve a computing or communications end that is generally accepted by those skilled in the art, whether such a standard is de facto, or arrived at by a moderated consensus of those skilled in the art. Throughout the following explanation, the word “traditional” may be used in a fashion similar to “standard,” where traditional refers to methodologies in general use, generally understood by those skilled in the art, or both, whether or not such methods have been approved by an official body.

Throughout the description following, although reference to a “user interface” may often occur within the context of a Web browser, the term may refer to any type of device or system capable of receiving user input and transmitting electronic data over any communications system or structure. Such devices and systems may include, for example, computers with accompanying computer monitors or displays, mobile or cellular telephones, portable communications or computational devices, and any and all software applications implemented on said systems. Examples of software applications may include Internet or Web browsers, operating systems, voice or telephonic communication systems or programs, and any computer program able to furnish sensory input or responses to a user, obtain cues from that user, or both.

Reference in the following descriptions to a “server” may refer to any and/or all of the following: hardware running software, or the software running on that hardware (or a group of such devices) that provide a service or services to another device or software entity. References to a “machine” in the description may refer to a hardware device or to a software device emulating hardware, such as “virtual” machines do, or even to several software “machines” running disparate Operating Systems on the same hardware device where they may share underlying hardware and software resources.

In the following description, the term “secure” may be synonymous with “secured;” that is, either term may have reference to the disposition of any device or system of devices such as a network or networked group of devices (whether hardware or software) for which precautions have been taken to protect the contents of said device or network from unauthorized access. Furthermore, the terms “secure device” and “secure device or network” may refer to the disposition of a device or network for which such precautions have been taken. The term secure may also be used in the sense of having taken precautions to protect access and entry points to a given device or network.

In one or more embodiments, the present invention may consist of a software application based on a modular architecture. Individual components within the architecture may be implemented as part of a larger framework (as separately operating applications running on the same application server) or as an Agent or control (such as an Active-X control) inserted within, or interfacing with applications or application components provided by third parties. The particular modular components and functionality which may be described in the description of an embodiment of the invention provided below are for purposes of example only, and are meant as aids to understanding. Other embodiments of the invention may be created in an architecture or framework lacking discrete modularized limits, or else as module elements having boundaries (i.e., modular assemblages) different than those examples provided here.

In the following description, tunneling may refer to the practice of accessing information by traversing firewalls by establishing standard protocol communication, and then overlaying on top of that protocol a different type of format, whatever the methodology used to achieve that overlay, whether by encrypting data within other data or placing packets within packets, or any other standard methodology used to achieve a tunneling effect. In other words, tunneling may refer to the practice of passing data structured in one communications protocol within the constraints of a second protocol.

“Reverse tunneling” as used in the following description may refer to the practice of initiating a request for Web Service and URL resources located within a secure device or network from within that device or network by sending a request from an agent to a server hosting center, and keeping that request “alive” (enabled) but inactive until needed to establish a connection to an entity which may be external to the aforesaid device or network that may request access to the aforementioned Web services and URL resources. Various methodologies may be used to achieve this affect. Embodiments of the present invention may use reverse tunneling to “piggy-back” SOAP service requests and responses over the HTTP or HTTPS protocol, to access resources normally isolated within secure topologies such as corporate LANs. The manner in which Web service and URL resources are accessed through the reverse tunnel may be considered a unique accomplishment of the invention.

In the following explanation, the terms “URL” (Universal Resource Locator), or “URL resources” may refer to any pointer to data or application functionality regardless of protocol or methodology used to point to and access that data or application functionality.

In the following description, the term “envelope,” may refer to a frame or packet of data that acts as a container for data. Likewise, “encrypted envelope” may refer to a frame or packet of data that acts as a container for data that has been encrypted. The frame itself may also be encrypted.

In the following explanation, the term “end point” may refer to the location of a Web service or URL resource. The term “external access” may be used in the context of accessing such an end point from a location external to the device or network hosting such an endpoint. In like manner, the term “remote” may be used to designate a location external to the device or network as described in the present invention.

In the following explanation, the term “identification token” may refer to a method or apparatus used to identify any portion of the present invention, or any user or users of said invention.

In the following description, the term “data hidden” may refer to intentionally disguising certain elements of data so that if the data is intercepted by unintended recipients, those recipients may be unable to use the data so hidden. Related terms, such as “data hiding,” “information hiding,” and “information hiding naming and path convention” may likewise all refer to the practice of disguising data elements. Likewise, the term “obfuscate” may be used to refer to this process of disguising data.

In the following explanation, the term “native” may be used to refer to data or program elements that are in the same format as the data or program elements of which they form a part or by which they are used or transmitted. Native may also indicate that there is no need to convert the format of such data or program elements prior to use by the entity to which such elements are native data or program elements.

In the following explanation, the term “personalized device” may refer to a device to which a given user has been granted usage rights.

### SYSTEM AND METHOD OVERVIEW

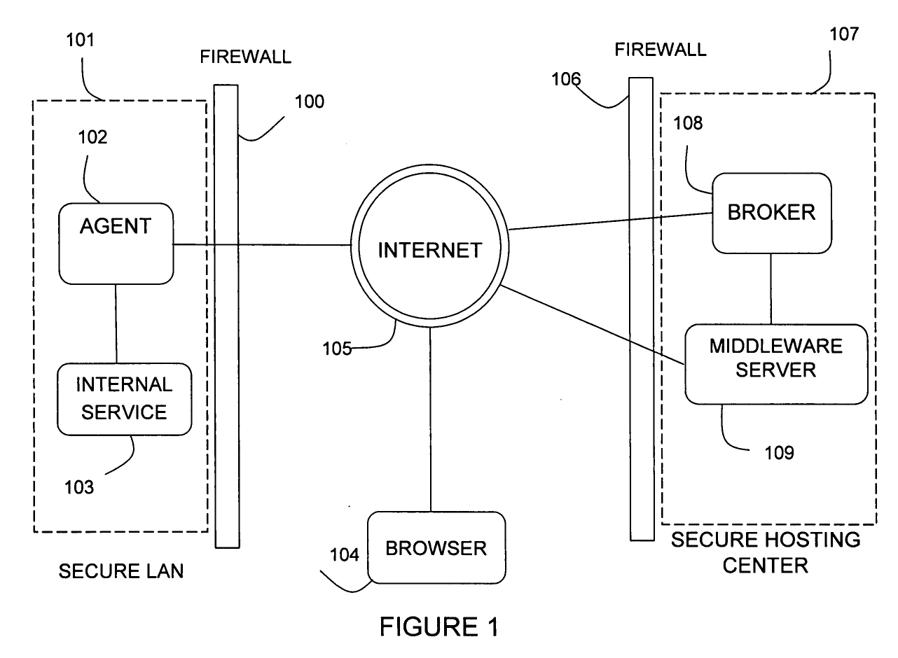

In the examples provided in FIGS. 1, 2, and 3 below, the physical and logical arrangement of one embodiment of the present invention may be provided. Those skilled in the art will understand that other physical and/or logical arrangements may be created to implement embodiments of the present invention.

FIG. 1 Example

In FIG. 1, Firewall 100 may protect Secure LAN 101 from unwanted traffic from Internet 105, thus creating a secure environment. To provide secure access to protected data, in one embodiment, a hosting center may be set up containing middleware software which provides an application interface to a user through a Web browser. In the example represented by FIG. 1, Firewall 106 may protect Secure Hosting Center 107 from unwanted access.

With an operational hosting center, an interested user within Secure LAN 101 may download an Agent 102 from the Secure Hosting Center 107. The Agent may come with some built in services: for example, a SOAP service wrapper for the MAPI interface to Microsoft Exchange Server, a custom SOAP service interface that may be used to access the folder and file system on the user's desktop, etc. These Agent “native” services may also include a SOAP wrapper for Google Desktop. This latter service may allow desktop searches to be preformed on the user's computer from anywhere on the Internet.

There may be two types of Agents available for users to download. The first may be a single user Agent that may provide the user access to resources on the user's own device, as well as access to any Web services and URL resources to which the user's network and device profile may have rights. The second Agent may be a multi-user Agent meant for corporate entities. Either Agent may allow a designated corporate applications administrator to register with the Agent any other desired Web services not provided by default with the Agent, however the multi-user Agent also allows multiple users to access data through a single Agent.

By registering the Web services with the Agent, two things may be accomplished: critical secured network Web services and URL resources may be made available to strongly authenticated users anywhere on the Web, and the Agent mapping table may apply a data hidden naming and path convention to the Web services so that unauthorized individuals may not be able to ascertain the true location of the secured network's internal resources. Since the Agent may reside securely within the LAN, there may be no exposure of this mapping to the outside world. Both versions of the Agent may also be configured to programmatically “discover” other Web services to which the user or users may have rights.

Within Secure Hosting Center 107, Middleware Server 109 (which may also incorporate a Web server) may serve up Web application content (including a user interface), while Broker 108 may act as a request handler and resource tracker, and may play a liaison role between Middleware Server 109 and Agent 102. In turn, Agent 102 may act as a liaison between the Broker and/or the Middleware Server 109 and Internal Service 103, as needed. Browser 104 may act as the Graphical User Interface (GUI) to an application served up by Middleware Server 109, and may be the point of initiation for requests for Agent 102 to access resources which may be located on Secure LAN 101, whether the installed Agent 102 uses service access points provided natively with Agent 102, or Internal Service 103 that may have been programmatically discovered by Agent 102 or registered with Agent 102 by a user (or administrator).

While FIG. 1 may illustrate a logical arrangement of an implementation of the present invention, any of the details of the physical arrangement may be changed without affecting the present invention. For instance, in FIG. 1, Middleware Server 109 and Broker 108 may be shown as separate entities, while they may in fact be located on the same physical device; indeed Broker 108 may be entirely incorporated within the logic of Middleware Server 109. Furthermore, while Hosting Center 107 may be shown behind Firewall 106 which may be different than Firewall 100, the entire system depicted within FIG. 1 may be configured to run within the confines of Secure LAN 101, where Middleware Server 109 and Broker 108 may act as an internal Web server providing LAN only access to an organization's internal services running within Secure LAN 101. Furthermore, the entire mechanism described in FIG. 1 may be configured and installed for use on a single device or entity, and need not be distributed as in the embodiment described here.

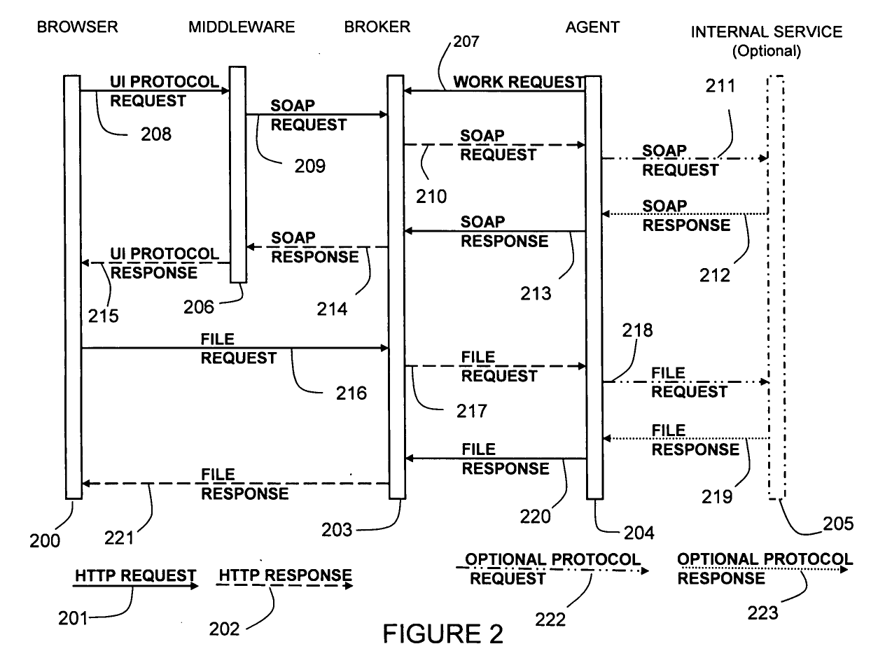

FIG. 2 Example

FIG. 2 may represent a snapshot of the interaction between the elements shown in FIG. 1, as that interaction may exist at any given moment in the life cycle of an application that may use the present invention to securely access protected Web services and URL resources that may be located within a secured network.

Once Agent 204 has been securely installed and any needed mappings have been made, the user may start the Agent. Upon starting, Agent 204 may initiate contact to a secure data hosting center and register with Broker 203 located within the secure hosting center, making a Work Request 207 and passing the Broker service a unique Tunnel ID (TID). The TID may provide Broker 203 a valid tunnel point with which to start requesting services during the life of that connection.

In FIG. 2, as an example of one embodiment of the current invention, all requests and responses by any entity including and to the left of Agent 204 may be made using the HTTP or HTTPS protocol (as indicated by HTTP Request 201 and HTTP Response 202), no matter how such requests may be otherwise labeled in the figure. This may be true because of the “piggy-backing” of other protocols over HTTP to achieve a tunneling mechanism to securely pass data of a type different than HTTP through a firewall. Requests and responses made by optional entities to the right of Agent 204 may be made in any optional protocol (as indicated by Optional Protocol Request 222 and Optional Protocol Response 223), and may then be forwarded by Agent 204 over HTTP. Furthermore, optional protocol requests and responses to the right of Agent 204 may represent optional access to Internal Service 205 which may represent Web services and/or URL resources not provided by default within an embodiment of the present invention. Such optional services and resources may be programmatically discovered by Agent 204, or registered with the Agent by a user (or administrator) within the secured environment.

In FIG. 2, once Agent 204 has sent Work Request 207 to Broker 203, Broker 203 may “shelve” Work Request 207 in a table or other data storage element either internal to or external from Broker 203, until the time is right for a response to Work Request 207. This response may be prompted by the request of a strongly authenticated user to access those services provided by or registered with the Agent. This user request may originate from a browser anywhere on the Internet (including from within the same LAN as that containing the Agent 204).

Until such a request from a user happens, the initial connection from the Agent may follow certain rules and procedures for either polling, pending requests, or re-initiating if a connection is ever severed through intermittent network traffic, or by a firewall. Should such an interruption occur, the tunnel Agent may merely connect to the Broker once again by making another Work Request 207. There may be no need for the Agent to be continuously connected, however for performance reasons, the connection may be maintained continuously. Even with a continuous connection, there may be no real overhead accrued by the data center servers because there may be no Internet traffic actually moving between that internal LAN and the outside data center until a response is provided to the initial Work Request from the Agent. This approach to maintaining connections to a given Agent may make the Broker and the applications the Broker services much more scalable than using a traditional threading approach to maintaining connections.

When a user uses a Browser 200 to log on to a Web application being served by Middleware Server 206, Browser 200 may send a request for SOAP service and/or URL resources to Middleware Server 206 securely residing within the hosting center. The request may be meant to invoke an Internal SOAP Service 205 behind Agent 204 in the protected LAN. Internal SOAP Service 205 may reside either on the machine hosting Agent 204, or on any other machine in the LAN that has a service or URL resource endpoint that has been registered with the Agent. The browser may forward that request in some format that may be interpreted by the Middleware Server. In one embodiment of the invention that format may be in a proprietary UI protocol.

When a user logs on, Browser 200 may send a UI Protocol Request 208 to Middleware Server 206. The Middleware Server may not be able to pass that request directly to the SOAP service endpoints inside a secure LAN, because the firewall may block access. Middleware Server 206 may interpret UI Protocol Request 208 as a need to send a SOAP Request 209 to Broker 203.To do so, the Middleware Server may translate the request to a SOAP service request overlaid or “tunneled” over HTTP, and may match the user's application login credentials to the Tunnel ID associated with those credentials at the time the account was created and the Agent downloaded. The Middleware Server may then pass the request with the associated TID to the Broker. Broker 203 may recognize SOAP Request 209 as a request for SOAP service resources either provided by or accessed through Agent 204. The Broker may then retrieve the original Work Request 207 from the appropriate Agent, and may respond to Work Request 207 previously made by Agent 204 with SOAP Request 210. It may be this process of “disguising” a request from an outside entity as a response to the initial Work Request 207 that may be interpreted as a “reverse” tunneling technique. It may be this reverse nature that may allow the Agent to provide services to the open Internet without having to have new ports opened in the firewall for access to those services.

If Agent 204 has received data hidden SOAP Request 210, Agent 204 may either process SOAP Request 210 using functionality provided as a part of Agent 204, or the Agent may map the data hidden SOAP service request to the true SOAP service or URL resource location, and may forward SOAP Request 210 as non-data hidden SOAP Request 211 to Internal Service 205, which may have previously been discovered or registered by a user with Agent 204 for authenticated access purposes. The SOAP service may make a response to that request and the response may traverse the same path in reverse, back out to the browser that initiated the first SOAP service request in the following way:

In an embodiment of the present invention, if Internal Service 205 has received non-data hidden SOAP Request 211 from Agent 204, when processing of SOAP Request 211 finishes, Internal Service 205 may send non-data hidden SOAP Response 212 to Agent 204, which may then obfuscate SOAP Response 212 and forward data hidden SOAP Response 213 to Broker 203. Broker 203 may then forward the response to Middleware Server 206 as data hidden SOAP Response 214. Middleware Server 206 may then translate SOAP Response 214 to UI Protocol Response 215 and forward UI Protocol Response 215 to Browser 200, where Browser 200 may use the UI Protocol Response 215 to update the browser content.

The SOAP service accessed (either in the Agent or the Internal Service) may generate a File Request URL that is passed back to the Browser through the SOAP and UI Protocol response paths discussed. The user may then choose to access the file. The Agent and/or the middleware “Broker” may also act to further obscure the true endpoints in the LAN by appending external “pretty names” to the URL requests, then using the Tunnel ID (TID) passed to the Broker by the Agent upon connection to create a map to the correct tunnel Agent. When the Agent receives these obscured mappings, the Agent may use its own mapping table to find the true endpoint to the SOAP service requested. This mechanism for reverse discovery and access of the file may create a more secure mechanism for file or resource access, since there may be no external access to the actual physical LAN file storage point for any file. Access may only be provided when a SOAP service calls for creation of a data hidden file request and dictates to the Agent the manner in which that request is formed. If this happens, Browser 200 may send a data hidden File Request 216 to the secure location hosting both Middleware Server 206 and Broker 207, the File Request 216 may be sent directly to Broker 203, by-passing Middleware Server 206 completely. If such an event occurs, Broker 203 may respond to Work Request 207 previously made by Agent 204 with a data hidden File Request 217. Agent 204 may then either interpret File Request 217 using functionality provided as a part of Agent 204, or may forward data hidden File Request 217 as non-data hidden File Request 218 to Internal Service 205, which may have previously been discovered or registered with Agent 204 for authenticated access purposes.

In an embodiment of the present invention, if Internal Service 205 has received non-data hidden File Request 218 from Agent 204, when processing of non-data hidden File Request 218 completes, Internal Service 205 may send non-data hidden File Response 219 to Agent 204, which may then obfuscate File Response 219 and forward data hidden File Response 220 to Broker 203, which may forward File Response 220 as File Response 221 to Browser 200 where the file may be delivered to the location requested by a user.

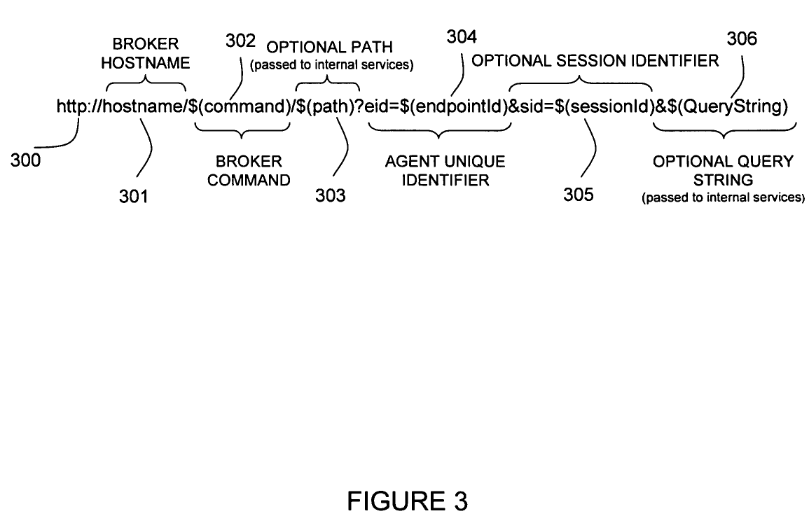

FIG. 3 Example

In an embodiment of the present invention, FIG. 3 may represent a URL served up to an end user within a browser context such as that shown in FIGS. 1 and 2 as discussed above. The discrete components of the URL as labeled in FIG. 3 may represent a data hidden pointer to both a particular Agent, a session for that Agent as held by a Broker such as that discussed in the contexts of FIGS. 1 and 2, and even data hidden paths and query strings for optional services not included in the original context of an Agent, but discovered or registered later by a user of the Agent once that has been downloaded.

For example, in FIG. 3, URL 300 may be partitioned into Broker Hostname 301, Broker Command 302, Optional Path 303, Agent Unique Identifier 304, Optional Session Identifier 305, and Optional Query String 306. Broker Hostname 301 may provide a pointer to the location of the secure hosting center where in an embodiment of the invention both the Middleware Server and the Broker which handles Agent communications are protected from the open Internet. Broker Command 302 may represent a command passed from the Middleware Server to the Broker instructing the Broker to send (for example) a SOAP request to a particular tunneling Agent. The Agent Unique Identifier 304 may contain a data hidden Tunnel Identification (TID) number representing a particular Agent. The Broker may use the Agent Unique Identifier 304 to identify the proper Agent to which the Broker may need to forward the SOAP Request from the Middleware Server. URL 300 may also include an Optional Session Identifier 305 which may be used to create a “dedicated” tunnel or Work Request that is assigned to that particular Agent session. For example, in the event that the Agent is configured for multiple user access, an Optional Session Identifier 305 may be included in URL 300 to ensure that the SOAP request is forwarded to the session corresponding to the user whose credentials initiated the presentation of URL 300. In addition, in an embodiment of the invention, if the SOAP service requested is not one delivered as a part of the Agent itself, but was an Internal Service discovered or registered by a user with the Agent after download and installation, URL 300 may also contain a data hidden Optional Path 303 pointing to the proper Service, as well as Optional Query String 306 containing a data hidden means of requesting a response from that optional Internal Service.

More On SOAP Service Access

There may be two types of SOAP service requests that may be made in one implementation of the present invention. The first are those requests made to SOAP services contained within the Agent. The second are those requests made to SOAP services running on the local device or network. In the case of the former, an embodiment of the present invention may have native control over how those requests are handled. However, if the corporate user has on-premise SOAP services deployed within the LAN that may not normally be accessible outside the firewall, an embodiment of the present invention may associate an “abstraction table” with the tunnel Agent that may allow a user to register Web service endpoints with some type of registry associated with the Agent. Doing so may create “mappings” that effectively disguise the internal LAN Web service endpoints prior to those services being requested from a browser external to the LAN. Such mappings may ensure that internal LAN endpoints are not exposed to unauthorized users. In effect, the tunnel Agent may “strip away” any end point information related to a SOAP request or any URL or resource information, and may replace that with information which only the tunnel Agent may be able to interpret. In the case of a multi-user Agent, multiple users may share the same routing information to access needed SOAP services.

Therefore, when a URL is passed to the browser, instead of the URL pointing to the actual location of the SOAP end point, the URL presented may consist of an obscured “external name”. When that URL is accessed by a user in the browser, the external name may be used to traverse through the data center machinery and then to the Agent which uses the registry mapping table to send the SOAP service request to the true endpoint of that internal LAN resource. When the internal SOAP service sends a response, the process may be reversed, thus maintaining the security of the Web service or URL resource.

In addition, mappings made for multiple user Agents, if they are made at the organization level may be inheritable. In other words, if the user designated by an organization to register a Web service with the Agent does so with sufficient rights, all users in the organization attempting to access those resources through a Web browser may be able to access those services properly, based on their personal user rights. This registration and use can take place “on the fly”—that is while the tunnel Agent is actually running, so that there may be no interruption of service while new resources are being registered with the Agent. In addition, if an organization creates a Web service for a resource that previously was unable to be accessed from outside the secure LAN, this new custom Web service may also be registered with the Agent in the same manner.

One added innovation of the present invention may be that the Agent may lack a user interface accessible at the installed location. This may have the effect of restricting access to the Agent registry to strongly authenticated users who may access the user interface for the Agent only through the secure hosting data center.

Although most mappings of Web services registered with the Agent may be made to create an obfuscating screen between LAN internal resources and the outside world, there may be situations where a mapping may be made from an externally valid name to a resource that is external to the LAN. This may not be a typical use of the registry table, but a peer-to-peer business situation may exist that makes creating such a mapping necessary, or at least desirable. It may even make sense for that internal registration to point to another Agent that is accomplishing tunneling and obfuscation for a resource internal to an entirely separate secure LAN.

Tunneling SOAP

An embodiment of the current invention may “package” standard SOAP services in such a way that SOAP service requests and responses may be sent through a firewall on a port associated with a standard protocol, and then across the Internet over that standard protocol. An embodiment of the present invention may make use of HTTP, SSL, or any other protocol and accompanying port deemed an adequate host for delivery of Web services and URL resource content.

In other words, an implementation of the present invention may use the basic mechanics of tunneling in a unique way. What may be unique is the use of a tunneling approach to deliver Web services and URL resource content over HTTP or any other suitable protocol (such as SSL). Using such an approach may provide semantic and logical data access to a secured network or the corporate enterprise, without having to rely on screen-scraping or the need to open new ports in a firewall.

An embodiment of the current invention may also send the SOAP service requests and responses within an encrypted “envelope” that is passed as clear text. This may accomplish two things: first, the SOAP contents may be protected from hackers. Second, firewalls configured to block SOAP calls for security reasons, may treat these requests as normal HTTP browser traffic and not interfere with the transfer of the SOAP calls. The use of “SOAP tunneling” may be an innovation of an implementation of the present invention because SOAP may be traditionally blocked and filtered out by firewalls, (even when a SOAP request is not made over a tunneling mechanism). In other words, a unique achievement of the present invention may not be merely the innovation of SOAP tunneling, but the packaging of SOAP service calls in such a way that the calls are not seen as SOAP because of being encrypted and compressed.

The encryption may be accomplished in a variety of ways (including SSL where appropriate), however the principle of sending the encrypted SOAP envelope as clear text over HTTP may cause the firewall to treat the SOAP service requests and responses as standard browser data transfers.

Creation of a Tunneling URL

An innovation of the present invention may be a “Tunneling URL”. A Tunneling URL may be a URL referencing a SOAP service to which the Agent may append the TID belonging to the Agent forming the URL. Because the TID may be part of the URL, when a user requests the resource represented by that URL, the browser may pass the URL back to the Middleware Server that uses the TID to identify that the resource in question resides behind a firewall and that the Broker needs to handle the request. When this URL is passed to the Broker, the Broker may interpret the TID and pass the request to the appropriate Agent handling requests for that secure resource. Although this may appear similar to URL redirecting, it is actually the delivery of content through the dynamic creation of a URL. Although the URL format is a standard, it is a standard that is flexible enough to allow innovators to create custom approaches to URL creation. In this case, the custom creation may simulate a “concrete” or unchanging URL, however, in reality, the URL may be an Agent SOAP service request forwarded through a Broker.

Tunnel Agent Security

The data on any given LAN accessed through this system may remain secure because the user's access rights on the computer and LAN on which the tunnel Agent has been installed may provide the security context for any attempt to access Web services or URL resources on the LAN. In other words, a user installing the tunnel Agent may have a given set of rights both on the LAN and the computer on which the tunnel Agent is installed. There may be no way to supersede those rights from a browser, because the Middleware Server providing the application interface from a secure hosting center may merely provide identification to the Agent for authentication purposes, and the Agent may then pass all such rights along to the Middleware Server as unchanged and unchangeable.

Furthermore, user logon security in the browser context may derive from stringent requirements for strong user authentication credentials which may be stored in the secure hosting center. Once the user is logged on, an Agent may be accessed using an identification number so that the user's secure login credentials to a computer or LAN network resources may never be transmitted over the open Internet, even in an encrypted form. In addition, other techniques for enforcing secure LAN resource access may be the denial of “back-click” access from Web pages not associated with the running Web application.

Multiple Agent Access from a Single UI

In an embodiment of the present invention, an end user may access multiple tunnel Agents within a single application context and UI. For example, a user may choose to install the Agent both on a work machine within a secure LAN, and also on a personal home computer. When the user provides the proper logon credentials to the hosting center, the single user interface may contain access points to both the work and home machines.

Multi-User Access

Although there may be a default install of a single user tunnel Agent, there may also be a multi-user version available, such as for corporate accounts. The single user version may provide the person downloading and installing the Agent, access to local desktop and computer information to which that user has access rights. The multi-user tunnel Agent may satisfy many connection requests from multiple users within a single connection to the Middleware Broker. In this way, many users may use a single tunnel Agent. Each user may still need to individually provide authentication to the secure hosting center, and while by default, the user may have access only to shared LAN services, these services may provide means to access individual computers.

In the single user Agent, the tunnel ID may uniquely identify which tunnel Agent may be connecting, however, with a multi-user Agent, a URL provided to a user in a browser may also include a unique identifier used to identify the person in the organization that authenticated in the hosting center and wants to access LAN resources.

Shared Access

An embodiment of the present invention may also include functionality that supports the notion of “buddies” and sharing access rights. For example, a user may want to share a resource such as a calendar or a portion of a calendar with another person. This may be accomplished by appending another unique identifier to each SOAP service request and response that identifies not only the person making the request, but a second user on whose behalf the request may be made. Together with these identifiers, usage rights and roles may also be sent with the SOAP service requests and responses. In other words, just as the user's rights to computer and LAN resources may be passed intact across the Internet, so too any rights a user may have granted another individual to access otherwise private data may be passed to an individual acting as a “buddy” to the primary user. These roles and rights may be managed behind the tunnel Agent in the appropriate Web service interfaces. So, in the example of sharing calendar information already alluded to, if an individual wants to share some calendar data to a “buddy,” and wants the buddy to be able see times marked as busy, but does not want the buddy to be able to see details of appointments, etc., then the user may set the roles and rights access that provide such a view, and then send an invitation to the buddy to view the calendar. When the buddy accesses the invitation through the data hosting center, part of the SOAP tunneling interface that provides a view of the calendar may include HTTP piggy-back cookies or information that in effect says “I am George allowing access to Fred, whom I invited to view these portions of my data.” This URL interpretation may occur in the Middleware portion of the data center, even though the URL presented to the end user may not reveal this complexity.

This ability to manage sharing of service resources and service calls may represent another significant innovation in an implementation of the present invention as, to date, there may not appear to be any other tunneling mechanisms that allow sharing resources while restricting the view granted to the sharee. Other tunneling techniques such as those that may provide user access through “screen-scraping” techniques may not provide a means for limiting access. If another user is granted access, that user may have the same rights and access as the primary user and may not be restricted in any way from accessing, copying, or deleting files, or running any installed application, or even reformatting the hard drive. On the other hand, an embodiment of the present invention may represent a type of provisioning based on rights and roles set by the primary user or the organization. For example, an organization may decide to restrict users from accessing files on their business computers, rather than to allow that service. Or, the organization may decide that users may access Exchange, but not their local mail store, or vice versa.

Broker Server Push

An embodiment of the present invention may include the concept of “server push”. In general terms, server push may refer to the ability of a server to update a client with a piece of data without the client making a request for that particular update.

In an embodiment of the invention, server push may refer to the Middleware Server's use of the Broker's ability to “shelve” a client Work Request in a table or other data storage element. Because the Broker may act as a request handler and resource tracker for any client connecting to the Middleware Server (not just an Agent), the Middleware Server may send an update to any client without the client requesting a particular update. The “reverse tunnel” description provided above may be viewed as a type of server push, in that the Agent may make a Work Request to the Broker which the Broker may then shelve until such time as the Middleware Server may forward a data request (which may contain a data update) from a browser through the Broker to the Agent.

A more common example of server push may be an “alert” element in the Graphical User Interface (GUI) of a Web application running in a browser. At the time of first connection, the alert element in the browser client may register with the Broker in the same way an Agent does. The Broker may then shelve this connection until such time the Middleware Server may send a data change to the client. The Broker may then retrieve the pending connection from the alert element and pass the data change to the alert element, making a visible update to the GUI. In one embodiment of the invention, an example of such a Broker enabled server push may be an area of an application interface showing access to a user's calendar that has been shared to a buddy. At the time the buddy accesses the calendar data, the Middleware Server may use the Broker to push the access alert to the primary user's browser client. For example, the buddy's name may change color in the interface, or a text message alerting the user that the buddy is viewing the calendar data may be presented to the primary user.

“On the Fly” Agent Updates

The Agent itself may be a Web service that the Middleware Server may access through SOAP calls. Through this means, the Middleware Server may update the Agent with new versions of the native Web services provided in the Agent, as well as entirely new services, all “on the fly”, or while the Agent is running. In addition, an end user accessing the Agent through the Middleware Server may rename the Agent, or even cause the Agent to uninstall itself or replace itself while the Agent is running.

Thus, a method and apparatus for accessing Web services and URL resources for both primary and shared users over a reverse tunnel mechanism is described. Individual embodiments described in the foregoing are exemplary only and should not be construed as limiting the present invention to those examples cited. The invention is delineated by the claims provided below, and their full range of quivalencies.

1. In a computing environment comprising a secure device or network, the secure device or network comprising one or more data or application sources together providing both Web services and URL resources, an apparatus for providing remote access to said services and resources comprising:
an agent on said secure device or network capable of interfacing with said secure device or network and with said Web services and URL resources contained within either or both; and
a secure middleware server configured to communicate with a user and pass communications securely between said user and said agent bi-directionally.

2. The apparatus of claim 1, wherein said agent is configured to allow remote access to said secure device or network without imposing a requirement for an administrator of said secure device or network to expose said services and resources through an end point or Web server destination.

3. The apparatus of claim 2, wherein said agent comprises a standards-based mechanism for secure external access of said Web services and URL resources.

4. The apparatus of claim 3, wherein said external access comprises passing Web services communications and URL resources over a tunneling mechanism, wherein said Web services communications and URL resources are passed over a standard communications protocol.

5. The apparatus of claim 4, wherein said tunneling mechanism comprises passing said Web services communications and URL resources as clear text.

6. (canceled)

7. The apparatus of claim 5, wherein said tunneling mechanism comprises passing said clear text within an encrypted envelope, compressed, or both.

8. The apparatus of claim 4, wherein said tunneling mechanism is configured to provide a user secure semantic and logical data access of said secure device or network from a remote location.

9. (canceled)

10. The apparatus of claim 1, wherein said agent comprises a data hiding mechanism to disguise physical address endpoints of said Web services and URL resources.

11. (canceled)

12. The apparatus of claim 1, wherein said agent is configured to pass said middleware server an identification token by which said agent is identified in a manner that obscures the final destination of communications between said middleware server and said agent.

13. The apparatus of claim 12, wherein said middleware server is configured to match said user's middleware logon credentials to said corresponding agent identification token to access said agent, wherein said user's login credentials for said secure device or network are never transmitted external to said device or network, even in an encrypted form.

14. (canceled)

15. The apparatus of claim 1, wherein said agent is configured as a multi-user agent, wherein agent access rights are granted to one or more individual users possessing rights to access said Web services and URL resources on said secure device or network.

16. (canceled)

17. (canceled)

18. The apparatus of claim 1, wherein said middleware server is configured to pass two types of Web service requests to said agent; a first type of request petitioning for access to Web services contained within said agent, and a second type of request petitioning for access to Web services contained within said secure device or network, but not within said agent.

19. (canceled)

20. The apparatus of claim 18, wherein said agent is configured to provide access to said Web services corresponding to said second type of requests through programmatic discovery of said Web services, or because an authorized user on said secure device or network registers interfaces and locations of said Web services in said agent.

21. (canceled)

22. (canceled)

23. (canceled)

24. (canceled)

25. (canceled)

26. (canceled)

27. (canceled)

28. (canceled)

29. (canceled)

30. The apparatus of claim 1, wherein said middleware server is configured to allow said user to access multiple agents within a single application context.

31. The apparatus of claim 1, wherein said agent is configured to append a unique identifier to a URL for the purpose of uniquely identifying a second user to whom said user has granted a portion of said user's access rights, wherein said unique identifier identifies both said user who has granted said portion of rights, and also said second user.

32. The apparatus of claim 31, wherein said agent is configured to allow usage rights and roles to be communicated with Web service and URL resource requests and responses.

33. (canceled)

34. The apparatus of claim 1, wherein said agent is configured to initiate communication with said middleware server by making a work request which said middleware server responds to only at such time as said user makes a request for access to said Web services or said URL resources.

35. The apparatus of claim 34, wherein said apparatus functions as a reverse tunnel mechanism, and wherein said reverse tunnel mechanism is a secure mechanism for access of said Web services and URL resources because access to said secure device or network is initiated only internally.

36. (canceled)

37. (canceled)

38. (canceled)

39. (canceled)

40. The apparatus of claim 4, wherein said tunneling mechanism is configured to generate a tunneling URL that is passed back to said user interface, wherein said tunneling URL is created dynamically.

41. The apparatus of claim 1, wherein said agent is configured to provide a Web service which said middleware server accesses through Web service calls.

42. The apparatus of claim 41, wherein said agent is configured to receive from said middleware server updates to said agent with functionality for said agent, and to install said functionality as a Web service, and wherein said middleware server sends updated versions of Web services provided in said agent, and wherein said middleware server installs new services within said agent, all while said agent is running and without interruption of services.

43. The apparatus of claim 1, wherein the entire apparatus is configured to run within the confines of said secure device or network, and-wherein said middleware server provides only to users internal to said device or network access to said Web services and URL resources contained within said secure device or network.

44. (canceled)

45. (canceled)

46. In a computing system, a method for remotely accessing Web services and URL resources located on a secure device or network, the method comprising:
interfacing with said Web services and URL resources from a remote location wherein said interfacing is managed locally via an agent located on said secure device or network; and
passing communications securely back and forth between said Web services and a remote user via a communications path comprising said agent and a middleware server.

47. The method of claim 46, wherein said communications path comprises traversing any firewalls seamlessly to allow remote access to said secure device or network without imposing a requirement for an administrator of said secure device or network to expose said services and resources through an end point or Web server destination.

48. The method of claim 47, wherein accessing said Web services and URL resources via said agent comprises a standards-based method for secure access from an external location.

49. The method of claim 48, wherein enabling said external access comprises passing Web services communications and URL resources over a tunneling mechanism, wherein said Web services communications and URL resources are passed over a standard communications protocol.

50. The method of claim 49, wherein enabling said tunneling mechanism to access said Web services and URL resources comprises passing said Web services communications and URL resources as clear text.

51. (canceled)

52. The method of claim 50, wherein enabling said tunneling mechanism to access said Web services and URL resources comprises passing said clear text within an encrypted envelope, compressed, or both.

53. The method of claim 49, wherein enabling said tunneling mechanism to access said Web services and URL resources comprises providing a user secure semantic and logical data access of said secure device or network from a remote location.

54. (canceled)

55. The method of claim 46, wherein enabling said agent to keep said device or network secure comprises using a data hiding mechanism to disguise physical address endpoints of said Web services and URL resources.

56. (canceled)

57. The method of claim 46, wherein enabling said agent to keep said device or network secure comprises said agent passing said middleware server an identification token by which said agent is identified in a manner that obscures the final destination of communications between said middleware server and said agent.

58. The method of claim 57, wherein keeping said device or network secure comprises configuring said middleware server to match said user's middleware logon credentials to said corresponding agent identification token in order to access said agent, wherein said user's login credentials for said secure device or network are never transmitted external to said device or network, even in an encrypted form.

59. (canceled)

60. The method of claim 46, wherein providing access to said Web services and URL resources comprises configuring said agent as a multi-user agent, wherein agent access rights are granted to one or more individual users possessing rights to access said Web services and URL resources on said secure device or network.

61. (canceled)

62. (canceled)

63. The method of claim 46, wherein providing access to said Web services and URL resources comprises configuring said middleware server to pass two types of Web service requests to said agent; a first type of requests petitioning for access to Web services contained within said agent; and a second type of request petitioning for access to Web services contained within said secure device or network, but not within said agent.

64. (canceled)

65. The method of claim 63, wherein passing and handling said second type of request comprises configuring said agent to provide access to said Web services through programmatic discovery of said Web services, or because an authorized user on said secure device or network registers interfaces and locations of said Web services in said agent.

66. (canceled)

67. (canceled)

68. (canceled)

69. (canceled)

70. (canceled)

71. (canceled)

72. (canceled)

73. (canceled)

74. (canceled)

75. The method of claim 46, wherein providing secure access to said Web services and URL resources comprises configuring said middleware server to allow said user to access multiple agents within a single application context.

76. The method of claim 46, wherein is configured to append a unique identifier to a URL for the purpose of uniquely identifying a second user to whom said user has granted a portion of said user's access rights, wherein said unique identifier identifies both said user who has granted said portion of rights, and also said second user.

77. The method of claim 76, wherein said agent is configured to allow usage rights and roles to be communicated with Web service and URL resource requests and responses.

78. (canceled)

79. The method of claim 46, wherein remotely accessing said Web services and URL resources comprises configuring said agent to initiate communication with said middleware server by making a work request which said middleware server responds to only at such time as said user makes a request for access to said Web services or said URL resources.

80. The method of claim 79, wherein said method creates a reverse tunnel mechanism, wherein said reverse tunnel mechanism provides a secure methodology for access of said Web services and URL resources because access to said secure device or network is initiated only internally.

81. (canceled)

82. (canceled)

83. (canceled)

84. (canceled)

85. The method of claim 49, wherein passing Web services communications and URL resources over a tunneling mechanism comprises configuring said tunneling mechanism to generate a tunneling URL that is passed back to said user interface, wherein said tunneling URL is created dynamically.

86. The method of claim 46, wherein remotely accessing said agent comprises configuring said agent to provide a Web service which said middleware server accesses through Web service calls.

87. The method of claim 86, wherein updating said agent comprises configuring said agent to receive updates from said middleware server with functionality for said agent and to install such functionality as a Web service, and wherein said middleware server sends updated versions of Web services provided in said agent, and wherein said middleware server installs new services within said agent, all while said agent is running and without interruption of services.

88. The method of claim 46, wherein accessing said Web services and URL resources comprises enabling said method to run within the confines of said secure device or network, and wherein said middleware server provides only to users internal to said device or network access to said Web services and URL resources contained within said secure device or network.

89. (canceled)

90. (canceled)

91. The apparatus of claim 1 wherein the middleware server comprises a broker component.

92. The method of claim 46, wherein the middleware server comprises a broker component.
